(19) United States
(12) Patent Application Publication
(10) Pub. No.: US 2024/0124038 A1
(43) Pub. Date: Apr. 18, 2024

(54) SERVICE CART DEVICE

(71) Applicant: Docktail Service, LLC, Orlando, FL (US)

(72) Inventors: Diane Kiely, Orlando, FL (US); Kyle Jensen, Orlando, FL (US)

(73) Assignee: Docktail Service, LLC, Orlando, FL (US)

(21) Appl. No.: 18/489,780

(22) Filed: Oct. 18, 2023

Related U.S. Application Data
(60) Provisional application No. 63/379,973, filed on Oct. 18, 2022.

(51) Int. Cl. B62B 3/00; B62B 5/00

(52) U.S. Cl. CPC B62B 3/005; B62B 5/0026; B62B 5/0096; B62B 2202/67; B62B 2301/044

(57) ABSTRACT

A service cart device to transport goods and services which may include a main body member, storage members, top member, attachment member, and computation interface. The device may also include wheel members, one or more of a drive unit, and sensor devices. The storage members may be carried by the main body member. The top member may be positioned above and carried by the main body member. The attachment member may be attached to an upper portion of the top member. The wheel members may be rotatably attached to a lower surface of the main body member. The drive units may selectively rotatably move at one or more of the wheel members. The sensor devices may be configured to detect adjacent objects and surfaces. The sensor devices may emit a detection signal relating to adjacent to object(s) and surface(s) detected. The top member may comprise a buoyant material.

### RELATED APPLICATIONS

This application claims priority under 35 U.S.C. § 119(e) of U.S. Provisional Patent Application Ser. No. 63/379,973 (Attorney Docket No. 5084.00001) filed on Oct. 18, 2022 and titled SERVICE CART DEVICE. The content of this application is incorporated herein by reference.

### FIELD OF THE INVENTION

The present invention relates generally to the field of service carts and, more specifically to the field of service cart devices that can include computer systems, motors, and sensors to enhance maneuverability.

### BACKGROUND OF THE INVENTION

The service industry and the industry for the supply of goods has been in continual search for advances the help increase the productivity, profitability, and customer convenience of their goods and services. Convenience is particularly important in view of customers being more attracted to convenient options rather than inconvenient ones to receive goods and services, unless his or her needs for a particular good or service outweighs the inconvenience of the location or operation of the provider of that particular good or service.

The cornerstone of providing increasing the productivity and profitability of providing goods or services to customers generally involves minimizing mistakes, reducing overhead, mitigating worker fatigue, and reducing or removing unnecessary costs or expenses. Furthermore, the cornerstone of increasing customer convenience in order to attract as many customers as possible at least includes having a customer convenient location, having fast service, having precise and accurate service, having organized service, and providing a variety of goods and/or services to the customer base.

The prior art have attempted to increase the productivity, profitability, and customer convenience of their goods and services in a number of ways including removing or reducing the human factor by automating certain job tasks to be completed by a robotic or computer-implemented device that is intended to make little to no mistakes and that will only require occasional maintenance instead of breaks or days off. Examples of the prior art include two-way audio systems for ordering at drive throughs, “burger-flipping” robotic arms, conveyor belts delivering orders of goods, computer-controlled and monitored cooking devices, and menu kiosks to intake orders instead of a cashier worker.

However, the prior art have failed to provide solutions for providers of goods and/or services to increase the productivity, profitability, and customer convenience of their goods and services to an even higher potential by implementing semi-automated or fully-automated systems that are capable of conducting and completing more than one or a small number tasks such that the semi-/fully-automated system is able to, or at least has the potential to, remove the human aspect from one or more job positions that typically would be filled by one or more workers.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a service cart device to transport goods and services. The device may include a main body member, more than one storage member, a top member, an attachment member, and/or a computation interface. The device may also include more than one wheel member, one or more of a drive unit, and more than one sensor device. The main body member may include a housing. The storage members may be carried by the main body member. The top member may be positioned above and carried by the main body member. The attachment member may be attached to an upper portion of the top member and the attachment member may be configured to be removably engaged with a lifting device. The computation interface may be carried by the housing. The wheel members may be rotatably attached to a lower surface of the main body member. The drive unit(s) may selectively rotatably move at one or more of the wheel members. The sensor devices may be in communication with the computation interface and the sensor devices may be configured to detect objects and surfaces that may be adjacent to the main body member and/or the top member. The sensor devices may emit one or more of a detection signal that may relate to object(s) and surface(s) detected by the sensor devices. The top member may include a buoyant material.

Each of the storage members may be moveable between an opened position and a closed position. The opened position may be defined as when at least an inner portion of the storage member is accessible. The closed position may be defined as when the inner portion of the storage member is not accessible. In some embodiments of the present invention, each of the storage members may include a respective active lock member that may be configured to move between a locked position and an unlocked position. The locked position may be defined as the respective active lock member being removably engaged with a portion of the main body member which may prevent movement of a respective storage member that the respective active lock member is carried thereby between the opened position and the closed position. The unlocked position may be defined as when the respective active lock member is not engaged with the main body member so that the respective storage member may be allowed to move between the opened position and the closed position. The respective active lock member may be configured to move from the unlocked position to the locked position when the respective storage member is moved to the closed position.

In some embodiments of the present invention, the wheel members may comprise two or more fixed wheels that may be positioned on an intermediary portion of the lower surface of the main body member, and the wheel members may also comprise two or more pairs of casters that may be positioned on opposing sides of the lower surface of the main body member from each other. The fixed wheels may have a circumference that may be larger than a circumference of the pairs of casters so that only one pair of the casters may be in contact with a ground surface at the same time as the fixed wheels. The one or more of the fixed wheels may be connected to the drive unit(s) and the one or more of the fixed wheels may be selectively rotatably moved thereby.

In some embodiments of the present invention, the pairs of casters may be movable between an extended position and a retracted position. The extended position of the casters may be defined as the caster pairs being extended to a position substantially level with the fixed wheels so that the fixed wheels and each of the caster pairs may be in contact with the ground surface at the same time. The retracted position of the caster pairs may be defined as the caster pairs being retracted and positioned so that only one pair of the caster pairs may be capable of being in contact with the ground surface at the same time as the fixed wheels.

In some embodiments of the present invention, the fixed wheels may be movable between an extended position and a retracted position. The extended position of the fixed wheels may be defined as the fixed wheels being extended to a position that may be further from the lower surface of the main body member than the caster pairs so that only one pair of the caster pairs may be capable of being in contact with the ground surface at the same time as the fixed wheels. The retracted position of the fixed wheels may be defined as the fixed wheels being retracted to a position so that each of the caster pairs may be in contact with the ground surface.

In some embodiments of the present invention, the device may include a power unit that may be carried by the main body member. The power unit may be configured to provide electrical power to one or more of the computation interface, the drive unit(s), and the sensor devices. The power unit may include a power interface that may be adapted to be removably engaged in communication with external power sources.

In some embodiments of the present invention, the computation interface may further include an olfactory system that may be configured to selectively produce and emit scents that may be relating to at least one of food, beverages, and fragrances.

In some embodiments of the present invention, the computation interface may be in communication with the drive unit(s). The computation interface may receive the detection signal(s) that may be emitted from the sensor device(s) and the computation interface may generate and send a wheel control signal that may be based on the detection signal(s), to the drive unit(s). The drive unit(s) may selectively rotatably move one or more of the wheel members based on the wheel control signal received.

In some embodiments of the present invention, the computation interface may be in communication with a global position system (GPS). The computation interface may receive geographic position data from the GPS system that may relate to geographic positioning of the main body member and/or the top member which may be relative to a surrounding environment. The computation interface may generate the wheel control signal based on one or more of the geographic position data and the detection signal(s) received.

In some embodiments of the present invention, the device may further comprising a data storage unit that may be in communication with the computation interface. The device may yet further include a virtual map that may be stored on the data storage unit. The virtual map may be accessible by the computation interface. The computation interface may generate and update the virtual map based on one or more of the detection signal(s) received and/or the geographic position data. The computation interface may generate the wheel control signal based on one or more of the geographic position data, the detection signal(s) received, and the virtual map.

In some embodiments of the present invention, the computation interface may be in communication with one or more of a user device. The computation interface and the user device(s) may be operable to transceive one or more service signals between one another. The service signal(s) may relate to one or more of available refreshments, available dock space location, monetary transactions, location of the at least one user device, location of the service cart device, user selected refreshment, selected dock space location, and/or estimated wait time.

In some embodiments of the present invention, upon the computation interface receiving one or more of the service signals from one of the user devices, the computation interface may determine an initial route that may be based on one or more of the virtual map and/or the service signal(s) received. The computation interface may generate the wheel control signal based on one or more of the geographic position data, the detection signal(s) received, the virtual map, the service signal(s) received, and/or the initial route. The computation interface may determine a secondary route that may be responsive to the detection signal(s) received, and may be determined based on one or more of the geographic position data, the virtual map, the service signal(s) received, and/or the initial route. The computation interface may generate the wheel control signal based on one or more of the geographic position data, the detection signal(s) received, the virtual map, the service signal(s) received, the initial route, and/or the secondary route.

In some embodiments of the present invention, each of the storage members may comprise a respective active lock member and each of the storage members may carry one or more of a refreshment that may comprise food or beverage. Each of the storage members may be moveable between an opened position and a closed position when the respective active lock member of the storage member is in an unlocked position. Each of the storage members may not be moveable to the opened position from the closed position when the respective active lock member of the storage member is in the locked position. Each respective lock member may be selectively operable by the computation interface to move between the locked position and unlocked position.

The computation interface may associate the user device that sent the service signal(s) containing selected refreshment data with one or more storage members by matching the refreshment(s) carried by the storage member(s) with the at least one service signal, which may define one or more of an associated storage member and an associated user device. The computation interface may selectively move the respective active lock member of the associated storage member(s) to the unlocked position upon a proximity detection of the associated user device and the associated storage member(s).

In some embodiments of the present invention, the communication between the computation interface and the user device(s) may be via one or more of a wireless network, wireless fidelity (Wi-Fi), Bluetooth, near field communication (NFC), radio-frequency identification (RFID), infrared (IR), long-range (LoRa), z-wave, ultrawideband (UWB), and light fidelity (Li-Fi). In some embodiments of the present invention, the device may include a control interface that may be carried by the main body member and the control interface may be in communication with the drive unit(s). The control interface may be selectively operable by users to cause one or more of the drive unit(s) to rotatably move one or more of the wheel members and which may cause the device to one of move forward, move backward, turn, and/or stop relative to a ground surface.

### BRIEF DESCRIPTION OF THE DRAWINGS

FIG. 1 is a perspective view of a service cart device according to an embodiment of the present invention.

FIG. 2 is another perspective view of the service cart device according to FIG. 1, showing an attachment member on a top member.

FIG. 3 is a partial perspective view of the service cart device of FIG. 1.

FIG. 4 is a perspective view of a service cart device according to an embodiment of the present invention having a curved top member and a computation interface.

FIG. 5 is a partial perspective view of a lower portion of a main body member of a service cart device according to an embodiment of the present invention, showing a pair of drive units.

FIG. 6 is a schematic illustration of a main body member of a service cart device according to an embodiment of the present invention with various storage members.

FIG. 7 is another schematic illustration of the main body member FIG. 6.

FIG. 8 is a schematic illustration of communication connections of a service cart device according to an embodiment of the present invention.

FIG. 9 is a schematic illustration of a service cart device according to an embodiment of the present invention, shown being in a surrounding environment or illustratively shown being representatively depicted by and in a virtual map.

Some embodiments of the present invention are illustrated as an example and are not limited by the figures of the accompanying drawings, in which like references may indicate similar elements.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a service cart device 100 that may advantageously be used to provide goods and transportation for such goods to individuals. Specifically, the service cart device 100 may be used to provide for goods, food, refreshments, and transportation of such to individuals in areas such as docks, condominiums, public parks, apartment complexes, amusement parks, and the like, and may include computer-implemented systems and sensors to facilitate operation of the service cart device 100.

The service cart device 100 according to embodiments of the present invention may advantageously be used to assist in transporting goods, such as food and refreshments, to individuals so that little to no human labor is needed to perform such a task. For example, and without limitation, the service cart device 100 may be utilized by a food and/or beverage service or company located at a maritime dock, wharf, or quay. However, it is known and contemplated that the service cart device 100 may be utilized by and provider or producer of any goods and/or services as understood by those skilled in the art such as, and without limitation, public parks, amusement parks, metropolitan areas, neighborhoods, parking lots, event locations, and any other location where one or more customers may be present.

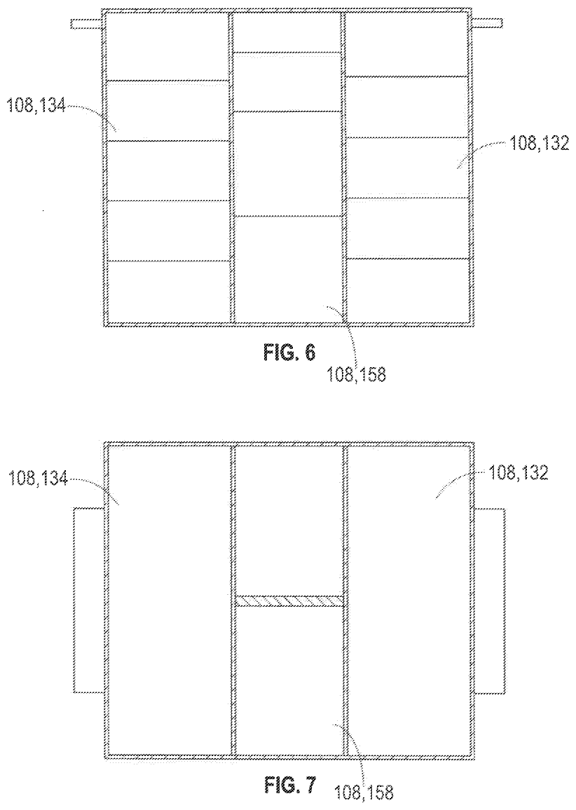

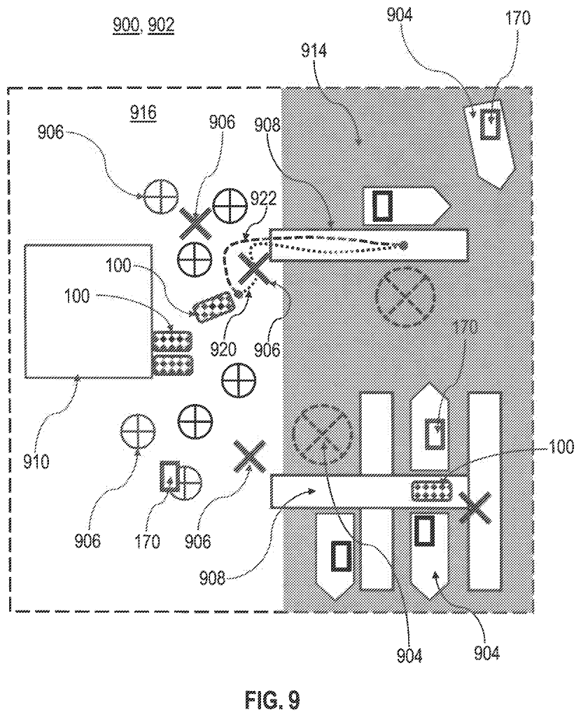

The service cart device 100 may be loaded with refreshments, such as food and beverages, that may have been requested by customers in a kitchen or other food/beverage preparation or production area such as a service station 910, as illustratively shown in FIG. 9. The service cart device 100 may also advantageously provide for storage areas that may be equipped to keep food warm or cold as needed, such as the storage members 108 illustratively shown in FIGS. 6-7. The service cart device 100 may be operable to be driven and/or self-driven to carry and/or transport the customer selected refreshment(s) to the designated customers that selected the refreshment(s). The service cart device 100 may be capable of self-propelling itself to designated customers using a global positioning system (GPS) 168. The service cart device 100 may also advantageously be equipped with detection capabilities to prevent the service cart device 100 from colliding with objects, falling over ledges, or falling into water while being driven or self-driven. Greater details on the driving and self-driving features of the service cart device 100 follows throughout below.

The service cart device 100 may also be functional to recharge and replenish at a designated area, such as a charging/replenishment station within a kitchen and/or service station 910 that may include power sources that are external from the device 100 which may be removably engaged with a power unit 152 that may be carried by the device 100 via a power interface 154, and the external power interfaces may provide electrical power to the power unit 152 which may charge the power unit 152. While the service cart device 100 is positioned at the charging/replenishment station, the service cart device 100 may be recharged while being loaded/unloaded by personnel. The service cart device 100 according to embodiments of the present invention may be advantageously used to reduce the amount of labor required in transporting goods, food, and beverages from one area to another, while also facilitating for monetary transactions, and maintaining food or beverages at desired temperatures. It should be understood that the service cart device 100 may be used for a variety of applications that require transportation of goods, food, and/or beverages over a distance, and the service cart device 100 is not limited to use in maritime environments.

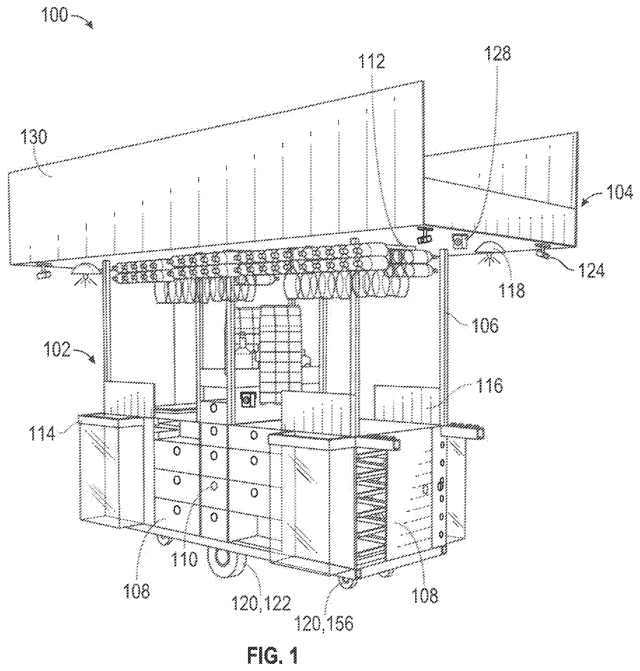

Now referring to FIGS. 1-2, 4, and 9, the service cart device 100 may include a main body member 102 and a top member 104. The top member 104 may be carried by and/or attached to the main body member 102. The top member 104 may be positioned above the main body member 102, and may be supported by the main body member 102 via a plurality of support members 106. The top member 104 may comprise flotation materials, and/or may comprise a watertight buoy that may be buoyant in water. Those skilled in the art will appreciate that the top member 104 may be made of any type of material that may provide buoyancy properties to the service cart device 100. This advantageously prevents the service cart device 100 from sinking if it is accidentally moved into water. As will be discussed in greater detail below, however, the service cart device 100 is intended to include computer-implemented systems to prevent such an incident, but in the interest of redundancy to protect the service cart device 100, such a feature may be advantageously included.

The top member 104 may include one or more display faces 130. The display faces 130 may be positioned on one or more side portions of the top member 104. The display faces 130 may be attached to the top member 104, and/or may be integrally formed with the top member 104 as a monolithic unit. The display faces 130 may include words, text, symbols, advertisements, or any other type of indicia thereon.

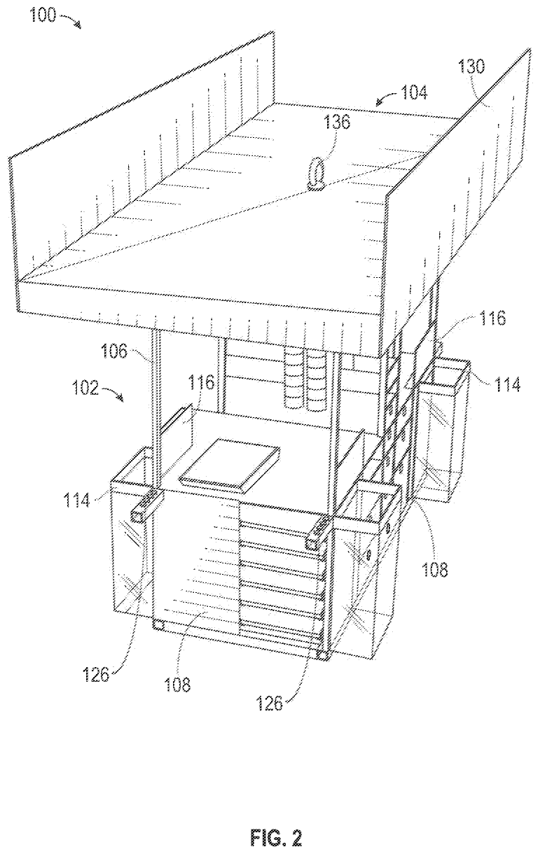

The top member 104 may also include an attachment member 136. The attachment member 136 may be attached to and/or positioned on an upper portion of the top member 104, as illustratively shown in FIG. 2. The attachment member 136 may be configured to be removably grasped, matingly engaged with, connected to, and/or attached to lifting devices including, cranes, pulleys, ropes, wenches, and/or any other lifting device that may be used with the attachment member 136 to lift and/or move the top member 104 and the service cart device 100 via the attachment member 136 as understood by those skilled in the art. As mentioned above, the top member 104 may be configured to be buoyant. A buoyant top member 104 may advantageously provide for a portion of the top member 104 floating above the surface of a body of water that the service cart device 100 may have fallen into so that the attachment member 136 may be visible for a lifting device (as mentioned above) to grasp the attachment member 136 and which may lift the service cart device 100 out of the body of water. The attachment member 136 may also advantageously allow for the use of a barge, boat, and/or water fairing transport that may have a lifting device to grasp the attachment member 136 to transport the service cart device 100 from an area (such as a dock) to be placed on the barge to then be transported on open waters. The attachment member 136 may also be used to return the service cart device 100 to a dock or a ground surface 916 from the barge using a lifting device to grasp the attachment member 136 and move the service cart device 100 back to the dock for the cart to be replenished and electrically charged. More detail on charging the service cart device 100 follows further below.

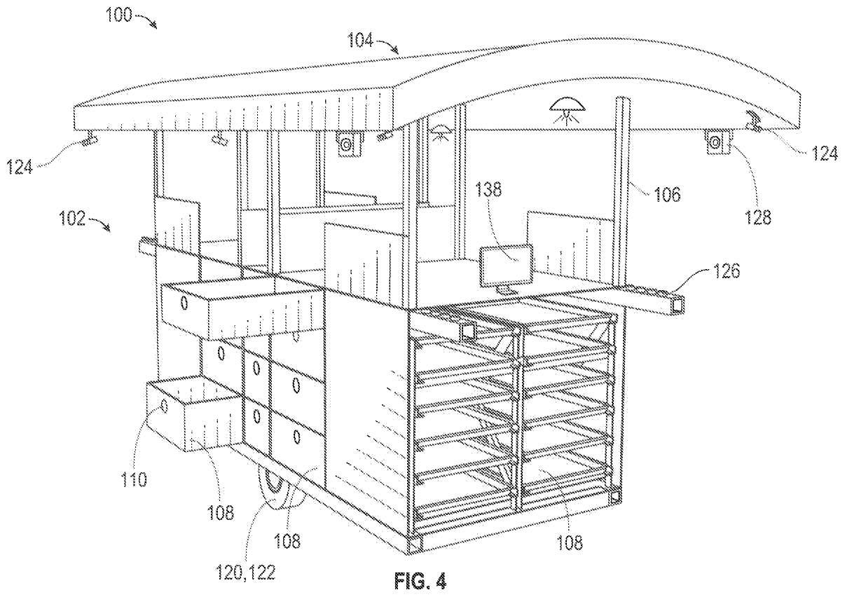

Some embodiments of the present invention may include a top member 104 that may be configured to fold. More specifically, the top member 104 may be configured to move between a folded position and a deployed position. The top member 104 may also be configured to be removably attached to the main body member 102. The top member 104 may further be configured and/or sized to have a length and/or width relatively larger than a length and/or width of the main body member 102. This is advantageous to reduce the amount of sunlight and/or weather from contacting the main body member 102. Some embodiments of the present invention may include a top member 104 having a sloped curvature shape extending from one side of the top member 104 to another side of the top member 104, as illustratively shown in FIG. 4. In the embodiment shown in FIG. 4, the top member 104 is curved. Those skilled in the art will appreciate that the top member can also have other shapes such as, for example, a v-shape having an apex.

In some embodiments of the present invention, the device 100 and/or the main body member 102 of the device 100 may include a plurality of storage members 108. The storage members 108 may be carried by the main body member 102. One or more of the storage members 108 may be configured and/or shaped to extend an entire length of the main body member 102. Specifically, one or more of the storage members 108 may extend from one side of the main body member 102 to another side of the main body member 102. One or more of the storage members 108 may be configured to be moveable and/or horizontally translatable between an opened position and a closed position, which may be in an inwards direction and an outwards direction, and relative to the main body member 102. The opened position may be defined as when at least an inner portion of the storage member 108 is visible. The closed position may be defined as when the inner portion of the storage member 108 is not visible. In some embodiments of the present invention, the opened position may be defined as when at least an inner portion of the storage member 108 is accessible, and the closed position may be defined as when the inner portion of the storage member 108 is not accessible. Examples of the storage members 108, and without limitation, may include one or more of a drawer, a shelf, a cabinet, a door, a refrigerator, a warmer, an oven, a cooler, and/or an insulated container. One or more of the storage members 108 may be configured to conform to the standard sheet pan sizing system, such as being configured to carry a half sheet pan within the storage member 108.

In some embodiments of the present invention, one or more of the storage members 108 may include an active lock member 110, which may be referred to as each storage member 108 including a respective active lock member 110. The active lock members 110 may be carried by and/or attached to a respective storage member 108. The active lock members 110 may be configured to move between a locked position and an unlocked position, which may be by operation of a user. The locked position may be defined as when an active lock member 110 is engaged to prevent the respective storage member 108 of the active lock member 110 from moving between and/or horizontally translating between the opened position and the closed position. The active lock member 110 may be configured to engage a portion of the main body member 102 when the active lock member 110 is in the locked position.

The unlocked position of the active lock member 110 may be defined as when the active lock member 110 of a respective storage member 108 is disengaged to allow the movement and/or horizontal translation of the respective storage member 108 between the opened position and the closed position. The active lock member 110 may be configured to disengage a portion of the main body member 102 when the active lock member 110 is in the unlocked position. The active lock member 110 may also be configured to readily return to the locked position from the unlocked position after being moved to the unlocked position by a user. Specifically, the active lock member 110 may be configured to remain in the locked position until a user operates the active lock member 110 to the unlocked position, and once a user stops operating the active lock member 110 (and/or when the respective storage member 108 that the active lock member 110 is carried thereby, and/or attached thereto, is moved to the closed position from the opened position) the active lock member 110 may readily/automatically move to the locked position.

An embodiment of the present invention may include one or more receptacle members 114 carried by and/or attached to the main body member 102. The receptacle members 114 may be configured to facilitate the use of containers, such as trash bags, thereon. The receptacle members 114 may be positioned adjacent one of the corners of the main body member 102. An embodiment of the present invention may also include one or more shield members 116. There may be a respective number of shield members 116 as there are receptacle members 114. The shield members 116 may be attached to the main body member 102 and may be positioned adjacent to a respective receptacle member 114. The shield members 116 may be positioned and/or oriented in a vertical direction. The shield members 116 may be configured to have a same or similar size, length, and/or width as the receptacle members 114.

The shield members 116 may have one side hingedly attached to a portion of the main body member 102. The shield members 116 may be sized to cover a significant portion of an upper area of a respective receptacle member 114. The shield members 116 may be configured to rotationally move between a covered position and an uncovered position. The covered position may be defined as when a shield member 116 is positioned to cover a significant portion of a respective receptacle member 114. The uncovered position may be defined as when a shield member 116 is positioned to reveal at least a portion of an inner area of the respective receptacle member 114.

The receptacle members 114 may be hingedly attached on one side of the receptacle member 114 to the main body member 102. The receptacle members 114 may be configured to move between a deployed position and a stored position. The deployed position of a receptacle member 114 may be defined as when the receptacle member 114 is rotationally moved to extend substantially away from the main body member 102. The stored position may be defined as when the receptacle member 114 is rotationally moved so that a substantial portion of an upper perimeter of the receptacle member 114 is abutting against a respective shield member 116 or the main body member 102.

An embodiment of the present invention may also include one or more hanger members 112. The one or more hanger members 112 may be positioned on and/or attached to a lower surface of the top member 104. The hanger members 112 may be configured to carry and/or secure one or more objects including glasses, mugs, bottles, wine bottles, wine glasses, tumblers, and/or any other filled or unfilled beverage container.

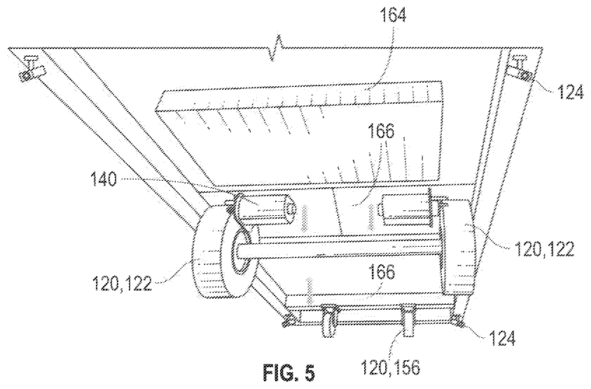

Now referring to FIGS. 1, and 4-5, an embodiment of the present invention may include one or more wheel members 120. The wheel members 120 may be positioned on a lower surface of the main body member 102. The wheel members 120 may include one or more of casters 156 and/or fixed wheels 122. There may be at least two pairs of casters 156 that may be positioned on opposing side portions of a lower surface of the main body member 102, and which may be relative to one of the other pairs of casters 156.

In some embodiments of the present invention, the plurality of wheel members 120 may comprise one or more of fixed wheels 122 and may comprise one or more of casters 156. For example, but without limitation, an embodiments of the present invention may include a plurality of wheel members 120 that comprise at least two fixed wheels 122 and at least two pairs of casters 156. The fixed wheels 122 may be positioned on and/or rotatably attached to an intermediary portion of a lower surface of the main body member 102. The at least two pairs of casters 156 may be rotatably and/or swivelably attached to the lower surface of the main body member 102, and the at least two pairs of casters 122 may be positioned on opposing sides of the lower surface of the main body member 102 relative to each other. For the purposes of the present invention, swivelably attached may be defined as being attached to an object and having the ability to swivel with respect to that object.

In some embodiments of the present invention, the pair of fixed wheels 122 may be configured to be proportionately larger in size relative to the casters 156. For example, but without limitation, the pair of fixed wheels 122 may have a circumference that is larger than a circumference of the casters 156. Those skilled in the art will notice and appreciate that having the pair of fixed wheels 122 being proportionately larger than and/or having a circumference larger than a circumference of the carts 156 may advantageously allow for only one pair of the casters 156 to be in contact with the ground or a surface at the same time as fixed wheels 122. This configuration may be advantageous in that the service cart device 100 may have increased maneuverability and a shorter turn radius than a turn radius if both of the two pairs of caters 156 were in contact with the ground at the same time as the fixed wheels 122.

One or more of the plurality of wheels 120, 122, 156 may be in mechanical communication with one or more of a drive unit 140. The drive unit 140 may be configured to transfer mechanical energy to and/or to selectively rotatably move one or more of the wheel members 120, 122, 156 that the drive unit 140 is in mechanical communication therewith. In some embodiments of the present invention which include multiple drive units 140 that are in mechanical communication with a respective fixed wheel 122, each of the drive units 140 may be configured to operate independently from one another to transfer mechanical energy to and/or to selectively rotatably move one or more of the one or more wheels 120, 122, 156 that the drive unit 140 is in mechanical communication therewith. In other embodiments of the present invention that include only one drive unit 140, the drive unit 140 may be in mechanical communication with one or more of the wheel members 120, 122, 156 and configured to transfer mechanical energy to and/or to selectively rotatably move one or more of the wheels 120, 122, 156.

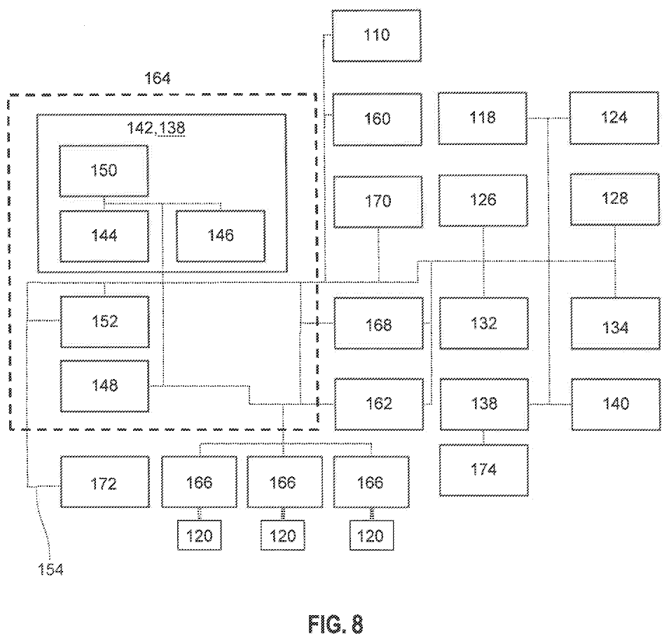

In some embodiments of the present invention, the drive unit(s) 140 may be in communication with a computation interface 138, illustratively shown in FIG. 8. The drive unit(s) 140 may be selectively operable and/or controlled by the computation interface 138 to cause the drive unit(s) 140 to selectively rotatably move one or more of the wheel members 120, 122, 156. In some embodiments of the present invention, the computation interface 138 may generate and/or send a wheel control signal that may be received by the drive unit(s) 140, and the drive unit(s) 140 may selectively rotatably move one or more of the wheel members 120, 122, 156 based on the wheel control signal received. Further details on the computation interface and the wheel control signal follows further below.

In some embodiments of the present invention, the wheel members 120, 122, 156 may be configured to actuate with respect to the main body member 102 and/or the lower surface of the main body member 102. The wheel members 120, 122, 156 may actuate between an extended position and a retracted position with respect to the main body member 102 and/or the lower surface of the main body member 102. The computation interface 138 may be in communication with one or more of the wheel members 120, 122, 156 and the computation unit 138 may selectively operate and/or control one or more of the wheel members 120, 122, 156 to actuate the one or more wheel members 120, 122, 156 between the extended position and the retracted position.

For example, and without limitation, in an embodiment of the present invention that includes a pair of fixed wheels 122 positioned at an intermediary portion of the lower surface of the main body member 102 and including two pairs of casters 156 rotatably and swivelably attached to opposing sides of the lower surface of the main body member 102, the pair of fixed wheel members 122 may be moveable between and extended position and a retracted position. The extended position of the fixed wheels 122 may be defined as the fixed wheels 122 being extended to a position that is further from the lower surface of the main body member 102 than the pairs of casters 156 so that only one pair of the casters 156 may be capable of being in contact with the ground surface at the same time as the fixed wheels 122. The retracted position of the fixed wheels 122 may be defined as the fixed wheels 122 being retracted to a position so that each of the casters 156 may be in contact with the ground surface such that the fixed wheels 122 may be in or may not be in contact with the ground surface.

Another example, but without limitation, in an embodiment of the present invention that includes a pair of fixed wheels 122 positioned at an intermediary portion of the lower surface of the main body member 102 and including two pairs of casters 156 rotatably and swivelably attached to opposing sides of the lower surface of the main body member 102, the pairs of casters 156 may be moveable between and extended position and a retracted position. The extended position of the casters 156 may be defined as the casters 156 being extended to a position substantially level with the fixed wheels 122 so that the fixed wheels 122 and each of the casters 156 may be in contact with the ground surface at the same time. The retracted position of the casters 156 may be defined as the casters 156 being retracted to a position so that only one pair of the casters 156 may be capable of being in contact with the ground surface at the same time as the fixed wheels 122.

In some embodiments of the present invention, the device 100 may include one or more actuation units 166. The actuation units 166 may be connected to and/or extending between one or more of the wheel members 120, 122, 156 and the main body member 102 and/or the lower surface of the main body member 102. The actuation units 166 may actuate the wheel members 120, 122, 156 and/or a respective one or more wheel members 120, 122, 156 between the extended position and the retracted position. The actuation units 166 may be in communication with the computation interface 138, and the actuation units 166 may be selectively operated and/or controlled by the computation interface 138 to cause the actuation units 166 to actuate and/or to actuate the wheel members 120, 122, 156 and/or a respective one or more wheel members 120, 122, 156 between the extended position and the retracted position.

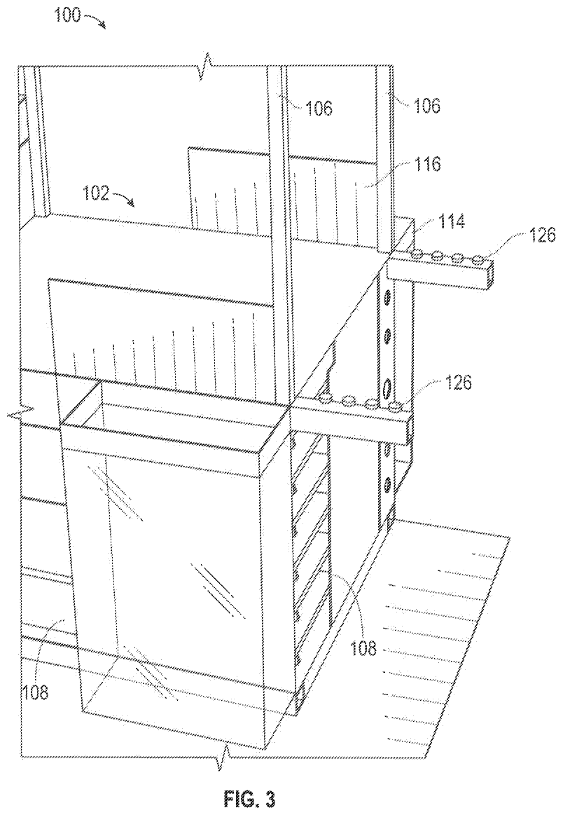

Now referring to FIGS. 1-5, and 8-9, as partially discussed above, an embodiment of the present invention may include one or more of illumination members 118, sensor devices 124, control interface 126, audio members 128, a power unit 152, a central controller 142, a control interface 126, a computation interface 138, a communication unit 148, a power interface 154, actuation unit(s) 166, a data storage unit 150, a processor 144, and/or a memory 146. As described further below, embodiments of the present invention may include and/or utilize one or more of a wireless network 162, a global positioning system (GPS) 168, and/or one or more of a user device 170.

The control interface 126 may be carried by and/or attached to the main body member 102. The one or more control interface 126 may be coupled in communication with the power unit 152, the central controller 142, the processor 144, the computation interface 138, the drive unit(s)140, and/or the power interface 154.

The control interface 126 and/or the computation interface 138 may be selectively operable by a user to control and/or operate the of the drive unit(s) 140 to cause one or more of the drive unit(s) 140 to selectively rotatably move one or more of the wheel members 120, 122, 156 which may cause the device 100 to move forward, move backward, turn, and/or stop relative to the ground surface. The control interface 126 may be selectively operable by users and read one or more control inputs inputted by a user via the control interface 126. The control interface 126 may send the control input(s) inputted by a user to the computation interface 138. In some embodiments of the present invention, the computation interface 138 may be selectively operable by users and read one or more control inputs inputted by a user via the computation interface 138.

The control interface 126 and/or the computation interface 138 may generate and send a wheel control signal to the drive unit(s) 140 to cause one or more of the drive unit(s) 140 to selectively rotatably move one or more of the wheel members 120, 122, 156, based on the control input(s) received. The control interface 126 may comprise of one or more buttons, switches, knobs, turn dials, levers, joysticks, sliders, pedals, and/or any other interface that may be used as the control interface 126 to be selectively operable by users and read control input(s) inputted via the control interface 126 as described above and as understood by those skilled in the art. In some embodiments of the present invention, the control interface 126 may be configured to only emit a wheel control signal while a user is making input on the control interface 126. For example, without limitation, when a user stops (or is not making an input) on the control interface 126, the drive units 140 may become and/or remain inactive.

The computation interface 138 may be carried by the main body member 102 and may be positioned on an upper surface of the main body member 102. The computation interface may be coupled in communication with the illumination members 118, the sensor devices 124, the power unit 152, the audio members 128, the central controller 142, the data storage unit 150, the processor 144, the memory 146, the control interface 126, the control interface 126, the communication unit 148, the drive units 140, and the power interface 154. The computation interface 138 may also be in communication with a wireless network 162.

The computation interface 138 may be configured to read, write, compute, run, process, receive, and transmit computer readable instructions, commands, and/or code. The computation interface 138 may send/receive and generate signals to, and from, one or more of the illumination members 118, sensor devices 124, control interface 126, audio members 128, the power unit 152, the central controller 142, the control interface 126, the communication unit 148, the power interface 154, the actuation unit(s) 166, the data storage unit 150, the processor 144, the memory 146, and/or active lock members 110. The communication between the computation interface 138 and the wireless network 162, and the communication to and/or from the computation interface 138 via the wireless network 162, may be via the communication unit 148. The computation interface 138 may monitor and selectively operate and/or control one or more of the illumination members 118, sensor devices 124, control interface 126, audio members 128, the power unit 152, the central controller 142, the control interface 126, the communication unit 148, the power interface 154, the actuation unit(s) 166, the data storage unit 150, the processor 144, the memory 146, and/or active lock members 110.

In some embodiments of the present invention, as mentioned further above, the computation interface 138 may be configured to register, compute, read, process, and transmit one or more control input(s) inputted by a user via the computation interface 138. The computation interface 138 may comprise, but without limitation, one or more of a tablet computer, a computation device, a touch screen device, a keyword, a keypad, and/or any other input or computation device that may be used as the computation interface 138. In some embodiments of the present invention, the computation interface 138 may comprise a processor 144, a memory 146, and/or a data storage unit 150 as each have been defined herein. In other embodiments of the present invention, the computation interface 138 may comprise a central controller 142 that may include a processor 144, a memory 146, and/or a data storage unit 150 as each have been described herein. Further details on the computation interface 138 follows throughout below.

The wireless network 162 may be in communication with the computation interface 138, the central controller 142, the processor 144, the memory 146, the data storage unit 150, the communication unit 148, the GPS 168, and/or the user device(s) 170. The wireless network 162 may facilitate and/or relay communication between the computation interface 138, the central controller 142, the processor 144, the memory 146, the data storage unit 150, the communication unit 148, the GPS 168, and/or the user device(s) 170. A network, such wireless network 162, may employ a wired and/or a wireless mode of communication. In general, any network topology may be used as the network 162. Any information, such as computer-readable data, instructions, commands, signals, and code, may be communicated via the wireless network 162.

In some embodiments of the present invention, the computation interface 138 may include an olfactory system 174. The olfactory system 174 may be configured to produce and/or emit scents. The scents emitted by the olfactory system 174 may include scents such as, food, beverages, pleasant smells, and fragrances that may include flowers, citrus, coffee, cocoanut, and/or imitation scents such as, but without limitation, grilled meat, Bar-BQ, pancakes, bacon, fried foods, and any other scent as understood by those skilled in the art to be used as a smell for increased marketing to, or enjoyment of, patrons and/or customers.

In some embodiments of the present invention, the computation interface 138 may be in communication with a global positioning system (GPS) 168. The communication between the computation interface 138 and the GPS 168 may be via the wireless network 162 and/or the communication unit 148. The computation interface 138 may be configured to monitor the geographic location of the service cart device 100, main body member 102, the top member 104, the computation interface 138, and/or one or more of the storage members 108 by utilizing and receiving geographic position data from the GPS 168. which may be via communication between the computation interface 138 and the GPS 168 via the wireless network 162. The GPS 168 may comprise computer systems and satellite devices operating in conjunction to monitor, calculate, generate, and send the geographic location of objects relative to a ground surface 916 and/or a surrounding environment 900 as geographic position data as understood by those skilled in the art. Further detail on the GPS 168 and geographic location data follows further below.

The computation interface 138 may also be configured to facilitate monetary transactions. The monetary transitions may be conducted via user inputted control inputs on the computation interface 138 and/or via one or more service signal(s) sent to, received from, and/or transceived between the computation interface 138 and the user device(s) 170. For the purposes of the present invention, transceived may be defined as receiving computer-readable data, sending computer-readable data, and any combination thereof such that computer-readable data may be either, and both, sent and received by the component.

The computation interface 138 may also be configured to monitor and index the refreshments that may be carried by the device 100 and/or carried by one or more of the storage members 108 with a goods index. The goods index may be stored by the data storage unit 150, and the goods index may be accessible by and managed by the computation interface 138. The goods index may also be managed by a user via one or more control inputs inputted via the computation interface 138.

The communication unit 148 may be carried by the main body member 102 or the housing 164. The communication unit 148 may be coupled in communication with the wireless network 162. The communication unit 148 may also be coupled in communication with the control interface 126, the central controller 142, the processor 144, the data storage unit 150, the GPS 168, the user device(s) 170, and/or the computation interface 138. The communication unit 148 may be configured to read, receive, send, transmit, compute, process, relay, and/or forward signals and/or computer-readable data/code to/from the wireless network 162 and to/from the control interface 126, the central controller 142, the processor 144, the data storage unit 150, and the computation interface 138. For example, but without limitation, the communication unit 148 may comprise a network card, Bluetooth module, wi-fi module, and/or any other device or module that may be used as the communication unit 148 to be in communication with a wireless network 162 as understood by those skilled in the art.

The central controller 142 may be carried by the main body member 102. The central controller 142 may also be carried by a housing 164 that is attached to the main body member 102, which may be attached at a lower portion of the main body member 102. The central controller 142 may be coupled in communication with the illumination members 118, the sensor devices 124, the control interface 126, the audio members 128, the data storage unit 150, the processor 144, the memory 146, the control interface 126, the computation interface 138, the communication unit 148, the drive units 140, the wireless network 162, and the power interface 154.

The data storage unit 150 may be coupled in communication with the processor 144 and/or the memory 146. The data storage unit 150 may be configured to receive, send, store, delete, read, and/or write computer readable information, such as, code, commands, instructions, and/or data. The data storage unit 150 may comprise of a disk drive, solid position drive, magnetic tape, flash drive, PCIe solid position drive, and/or any other data storage device that may be used as the data storage unit 150 as understood by those skilled in the art.

The processor 144 may be coupled in communication with the data storage unit 150 and/or the memory 146. The processor 144 may be configured to send, receive, compute, process, execute, store, read, write, and/or delete computer readable information, such as, code, commands, instructions, and/or data. The processor 144 may comprise of a central processing unit (CPU), a graphics processing unit (GPU), a microcontroller, a microprocessor, an embedded processor, a digital signal processor, and/or any other computation device that may be used as the processor 144 for an embodiment of the present invention as understood by those skilled in the art.

The memory 146 may be coupled in communication with the data storage unit 150 and/or the processor 144. The memory may be configured to receive, send, store, delete, read, and/or write computer readable information, such as, code, commands, instructions, and/or data. The data storage unit 150 may comprise of a disk drive, solid state drive, magnetic tape, flash drive, PCIe solid state drive, random access memory (RAM), DRAM, SRAM, read-only memory (ROM), PROM, EPROM, EEPROM, MROM, non-volatile computer-readable memory, volatile computer-readable memory, and/or any other memory device that may be used as the memory 146 for an embodiment of the present invention as understood by those skilled in the art.

The power unit 152 may be carried by the main body member 102 and/or the power unit 152 may be carried by the housing 164. The power unit 152 may be coupled in communication with, and may configured to provide electrical power to, the illumination members 118, the sensor devices 124 control interface 126, the audio members 128, the central controller 142, the data storage unit 150, the processor 144, the memory 146, the control interface 126, the computation interface 138, the communication unit 148, the active lock member(s) 110, and/or the power interface 154. The power unit 152 may comprise of a battery, rechargeable battery, non-rechargeable battery, replaceable battery, power regulator, power supply, voltage regulator, current regulator, inverter, rectifier, power storage device, and/or any other power storage and/or regulating device that may be used as the power unit 152 as understood by those skilled in the art.

The power interface 154 may be carried by the main body member 102, and/or the power interface may be positioned within the housing 164. The power interface 154 may be in communication with the power unit 152. The power interface 154 may be configured to be coupled with an external power source 172 to receive electrical power from the external power source 172 via the power interface 154 may. The power interface 154 may be configured to charge the power unit 152 with electrical energy from the external power source 172 in some embodiments of the present invention wherein the power unit 152 comprises one or more of a battery or any other electrical power storage and power supply device as mentioned above.

The one or more illumination members 118 may be positioned on and/or attached to a lower surface of the top member 104. The illumination members 118 may be coupled in communication with the central controller 142, the processor 144, the power unit 152, a control interface 126, and/or a computation interface 138. The illumination members 118 may be configured to generate light, and may be configured to be turned on, turned off, and/or dimmed by the central controller 142, the processor 144, the power unit 152, the control interface 126, and/or the computation interface 138.

The one or more audio members 128 may be positioned on and/or attached to the lower surface of the top member 104 and/or an upper portion of the main body member 102. The audio members 128 may be coupled in communication with the central controller 142, the processor 144, the power unit 152, the control interface 126, the wireless network 162, the data storage unit 150, and/or the computation interface 138. The audio members 128 may be configured to emit sounds waves from sound signal instructions received from central controller 142, the processor 144, the power unit 152, the control interface 126, the wireless network 162, the data storage unit 150, and/or the computation interface 138. The sounds emitted from the audio members 128 may include audio such as, music, voices, and sound recordings.

One or more of the sensor devices 124 may be positioned on and may be attached to a lower portion the top member 104. The sensor devices 124 also may be positioned on and may be attached to a lower portion of the main body member 102. The sensor devices 124 may be coupled in communication with the drive units 140, the computation interface 138, the central controller 142, the processor 144, the communication unit 148, the power unit 152, the control interface 126, and/or the audio members 128. The sensor devices 124 may comprise of an optical sensor, spatial sensor, sonar sensor, laser sensor, ultrasound sensor, visible light sensor, infrared sensor, and/or any other type of sensor that may be configured to determine, sense, detect, calculate, and/or measure the distance of, the presence of, the absence of, and/or proximity of objects and/or surfaces relative to one or more of the service cart device 100, the sensor device 124, the wheel members 120, the main body member 102, the top member 104, and/or one or more of the storage members 108.

For example, but without limitation, the objects 906 and surfaces detected by the sensor devices 124 may include rocks, pillars, poles, debris, animals, birds, pets, people, the ground surface 916, tables, chairs, fences, walls, debris, dock platforms, walkways, hills, water lines, bodies of water, watercrafts, and/or spilled substances. The sensor devices 124 may be configured to emit one or more of a detection signal relating to a determined, sensed, detected, calculated, and/or measured distance of, presence of, absence of, and/or proximity of one or more objects and/or surfaces relative to one or more of the service cart device 100, the sensor device 124, the wheel members 120, the main body member 102, the top member 104, and/or one or more of the storage members 108.

The emitted detection signal(s) may be received by the computation interface 138. The computation interface 138 may generate a wheel control signal based on the detection signal(s) received. The computation interface 138 may send the wheel control signal to one or more of the drive unit(s) 140. The wheel control signal may be received by the one or more drive unit(s) 140 and the drive unit(s) 140 may selectively rotatably move at least one of the wheel members 120, 122, 156 based on the wheel control signal received from the computation interface 138. In some embodiments of the present invention, the computation interface 138 may directly selectively operate and/or control one or more of the drive unit(s) 140 to cause the drive unit(s) 140 to selectively rotatably move at least one of the wheel members 120, 122, 156 based on the detection signal(s) received by the computation interface 138 from the sensor device(s) 124.

In some embodiments of the present invention, and as described further above, the computation interface 138 may to monitor the geographic location of the service cart device 100, main body member 102, the top member 104, the computation interface 138, and/or one or more of the storage members 108 by utilizing and receiving geographic position data from a global positioning system (GPS) 168. The computation interface 138 may generate the wheel control signal based on the detection signal(s) received and/or the geographic position data received, and the computation interface 138 may send the wheel control signal to one or more of the drive unit(s) 140. The wheel control signal may be received by the one or more drive unit(s) 140, and the drive unit(s) 140 may selectively rotatably move at least one of the wheel members 120, 122, 156 based on the wheel control signal received from the computation interface 138. In some embodiments of the present invention, the computation interface 138 may directly selectively operate and/or control one or more of the drive unit(s) 140 to cause the drive unit(s) 140 to selectively rotatably move at least one of the wheel members 120, 122, 156 based on the detection signal(s) received and/or the geographic position data received by the computation interface 138.

In some embodiments of the present invention, the data storage unit 150 may store a virtual map 902 that may be accessible by the computation interface 138. The computation interface 138 may be configured to generate and/or update the virtual map 902. The virtual map 902 may be generated and/or updated by the computation interface 138 based on one or more detection signal(s) received by the computation interface 138 and/or the geographic position data received by the computation interface 138. The virtual map 902 may comprise a representation of a surrounding area 900 and the location of objects and/or surfaces therein which may include one or more of an object 906, a surface 908, a service station 910, available dock location(s) 912, a ground surface 916, one or more user device(s) 170, a body of water 914 including water line(s), and the location of the service device 100 which may include the location of the main body member 102, top member 104, and/or storage members 108 of the device 100, as illustratively shown in FIG. 9. In some embodiments of the present invention, the virtual map 902 may also include a representation of locations of other service devices 100 within and relative to the surrounding area 900 represented by the virtual map 902.

In some embodiments of the present invention, the computation interface 138 may generate the wheel control signal(s) based on the detection signal(s) received, the geographic position data received, and/or the virtual map 902 and send the wheel control signal to one or more of the drive unit(s) 140. The wheel control signal may be received by the one or more drive unit(s) 140, and the drive unit(s) 140 may selectively rotatably move at least one of the wheel members 120, 122, 156 based on the wheel control signal received from the computation interface 138. In some embodiments of the present invention, the computation interface 138 may directly selectively operate and/or control one or more of the drive unit(s) 140 to cause the drive unit(s) 140 to selectively rotatably move at least one of the wheel members 120, 122, 156 based on the detection signal(s) received, the geographic position data received, and the virtual map 902.

As mentioned further above, the computation interface 138 may be removably connected in communication with one or more user device(s) 170. The communication between the computation interface 138 and the user device(s) 170 may be via the communication unit 148, indirect communication via the wireless network 162, and/or a direct communication between the computation interface 138 and the user device(s) 170. For example, but without limitation, the direct communication between the computation interface 138 and the user device(s) 170 may comprise one or more of wireless fidelity (Wi-Fi), Bluetooth, near field communication (NFC), radio-frequency identification (RFID), infrared (IR), long-range (LoRa), z-wave, ultrawideband (UWB), and light fidelity (Li-Fi).

The computation interface 138 and the user device(s) 170 may be configured to transceive data and/or signals to, from, and between one another comprising one or more service signals. The service signal(s) may relate to one or more of available refreshments, refreshments carried by the service device 100, available dock space location(s) 904, monetary transactions, geographic location of the user device 170, geographic location of the service cart device 100, user selected refreshment(s), selected available dock space location 904, and/or an estimated wait time. The estimated wait time may relate to the amount of time a user of the user device 170 can expect to wait before receiving a refreshment delivery from the device 100 and the user of the user device 170 has selected a refreshment. As understood by those skilled in the art, the user device(s) 170 may comprise any type of computer device that may be capable of communication, receiving, processing, sending computer-readable data and information and that may be operable by a user to receive, process, compute, and/or react to, user inputs and/or visually display or otherwise convey information and other data to the user. Examples of a user device 170 may include, without limitation, a personal computer, a tablet, a cellular phone, and a laptop computer.

The computation interface 138 may receive the service signal(s) from the user device 170 and associate one or more of selected refreshment(s), selected dock space location, completed monetary transaction(s), and/or geographic location of the user device 170, with the user device 170 that sent the service signal(s) to the computation interface 138. The computation interface 138 may generate wheel control signal(s) based on one or more of detection signal(s) received, the geographic position data received, the virtual map 902, and/or the data received by the computation interface 138 the via the service signal(s) send by the user device 170. The computation interface 138 may send the wheel control signal to be received by one or more of the drive unit(s) 140, and which may cause the drive unit(s) 140 to selectively rotatably move at least one of the wheel members 120, 122, 156 based on the wheel control signal received to move the service cart 100 to a location to deliver the selected refreshments to the user of the associated user device 170. In some embodiments of the present invention, the computation interface 138 may directly selectively operate and/or control one or more of the drive unit(s) 140 to cause the drive unit(s) 140 to selectively rotatably move at least one of the wheel members 120, 122, 156 based on the detection signal(s) received, the geographic position data received, the virtual map 902, and/or the service signal(s) received to cause the service cart 100 to move towards the location to deliver the selected refreshments to the user of the associated user device 170.

In some embodiments of the present invention, the computation interface 138 may determine an initial route 906 based on the virtual map 902 and the service signal(s) received. The initial route 906 may relate to a route for the computation interface 138 and/or service cart 100 to follow to and move along towards the location to deliver the selected refreshments to the user of the user device 170, as illustratively shown in FIG. 9. The computation interface 138 may generate the wheel control signal(s) based on one or more of detection signal(s) received, the geographic position data received, the virtual map 902, the service signal(s) received, and/or the initial route 906 generated. The computation interface 138 may send the wheel control signal to be received by one or more of the drive unit(s) 140, and which may cause the drive unit(s) 140 to selectively rotatably move at least one of the wheel members 120, 122, 156 based on the wheel control signal received to move the service cart 100 to a location to deliver the selected refreshments to the user of the associated user device 170. In some embodiments of the present invention, the computation interface 138 may directly selectively operate and/or control one or more of the drive unit(s) 140 to cause the drive unit(s) 140 to selectively rotatably move at least one of the wheel members 120, 122, 156 based on the detection signal(s) received, the geographic position data received, the virtual map 902, the service signal(s) received, and/or the initial route 906 to cause the service cart 100 to move towards the location to deliver the selected refreshments to the user of the associated user device 170.

In other embodiments of the present invention, the computation interface 138 may determine and/or generate a secondary route 920, which may be determined and/or generated upon the computation interface 138 receiving a detection signal from the sensor device(s) 124 that relates to an object 906 or surface 908 located on the initial route 906 that may be blocking and/or otherwise preventing the service device 100 from being allowed to move along the initial route 906 toward the delivery location of the associated user device 170. The computation interface 138 may generate and/or determine the secondary route 902 based on one or more of the virtual map 902, the service signal(s) received, and the initial route 906. The computation interface 138 may generate the wheel control signal(s) based on one or more of detection signal(s) received, the geographic position data received, the virtual map 902, the service signal(s) received, the initial route 906, and/or the secondary route 920. The computation interface 138 may send the wheel control signal to be received by one or more of the drive unit(s) 140, and which may cause the drive unit(s) 140 to selectively rotatably move at least one of the wheel members 120, 122, 156 based on the wheel control signal received to move the service cart 100 to the location to deliver the selected refreshments to the user of the associated user device 170. In some embodiments of the present invention, the computation interface 138 may directly selectively operate and/or control one or more of the drive unit(s) 140 to cause the drive unit(s) 140 to selectively rotatably move at least one of the wheel members 120, 122, 156 based on the detection signal(s) received, the geographic position data received, the virtual map 902, the service signal(s) received, the initial route 906, and/or the secondary route 920 to cause the service cart 100 to move towards the location to deliver the selected refreshments to the user of the associated user device 170.

In some embodiments of the present invention, the computation interface 138 may be in communication with the active lock members 110 of each of the storage members 108. The computation interface 138 may operate and/or control one or more of the active lock members 110 to move between the locked position and the unlocked position, which may be based upon the computation interface 138 determining that the associated user device 170 is in proximity and/or near proximity to the service device 100. The computation interface 100 may associate the associated user device 170 with one or more of the storage members 108 based on the selected refreshment data received from the associated user device 170 via the service signal(s) received by the computation interface 138 from the associated user device 170, defining one or more associated storage member(s) 108. Upon the computation interface 138 determining that the associated user device 170 is in proximity and/or near proximity with the service device 100, the computation interface 138 may operate and control the active lock member(s) 110 of the associated storage member(s) 108 from the locked position to the unlocked position.

Now referring to FIGS. 6-8, the storage members 108 may include heated storage containers 108, 132 and/or cold storage containers 108, 134. The heated storage containers 108, 132 and/or the cold storage containers 108, 134 may comprise of insulation materials such as Styrofoam and polyurethane or any other insulation material as understood by those skilled in the art. The heated storage containers 108, 132 and/or the cold storage containers 108, 134 may include heating and/or cooling elements such as a resistance heater 160, a heat pump, a heat lamp, a steam table, a display warmer, a refrigerator, a cooler, a dry ice carrying unit, and any other heating and/or cooling element as understood by those skilled in the art. The resistance heater 160 may be in communication with the power unit 152, the central controller 142, the computation interface 138, and/or the power interface 154. The resistance heater 160 may be configured to be controlled by the power unit 152, the central controller 142, the computation interface 138, and/or the power interface 154 to be turned on, off, and/or set at a heat or temperature level setting.

The storage members 108 may also include atmospheric storage members 108, 158. The atmospheric storage members 108, 158 may comprise of a drawer, cabinet, storage area, and/or shelf. The atmospheric storage members 108, 158 may be configured to be in various dimensions of length, height, and width. The atmospheric storage members 108, 158 may be used as storage areas that do not have temperature control or climate control elements equipped.

The wireless network 162 may comprise of a wi-fi router, a cellular network, a Bluetooth connection, a wi-fi network, and/or any other wireless network that may be used to facilitate computer-readable data transfers as understood by those skilled in the art.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the description of the invention. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A service cart device to transport goods and services, the device comprising:
a main body member including a housing;
a plurality of storage members carried by the main body member;
a top member positioned above and carried by the main body member;
an attachment member attached to an upper portion of the top member and configured to be removably engaged with a lifting device;
a computation interface carried by the housing;
a plurality of wheel members rotatably attached to a lower surface of the main body member;
at least one drive unit to selectively rotatably move at least one of the plurality of wheel members; and
at least one sensor device in communication with the computation interface and configured to detect objects and surfaces adjacent to the main body member and the top member;
wherein the at least one sensor device emits at least one detection signal relating to objects and surfaces detected; and
wherein the top member comprises a buoyant material.

2. The device of claim 1, wherein each of one of the plurality of storage members are moveable between an opened position and a closed position; wherein the opened position is defined as when at least an inner portion of the storage member is accessible; wherein the closed position is defined as when the inner portion of the storage member is not accessible.

3. The device of claim 2, wherein each one of the plurality of storage members comprises a respective active lock member that is configured to move between a locked position and an unlocked position; wherein the locked position is defined as the respective active lock member being removably engaged with a portion of the main body member to prevent movement of a respective storage member of the plurality of storage members between the opened position and the closed position; wherein the unlocked position is defined as when the respective active lock member is not engaged with the main body member so that the respective storage member is allowed to move between the opened position and the closed position; and wherein the respective active lock member is configured to move from the unlocked position to the locked position when the respective storage member is moved to the closed position.

4. The device of claim 1, wherein the plurality of wheel members comprise at least two fixed wheels positioned on an intermediary portion of the lower surface of the main body member, and comprises at least two pairs of casters positioned on opposing sides of the lower surface of the main body member; wherein the at least two fixed wheels have a circumference that is larger than a circumference of the at least two pairs of casters so that only one pair of the at least two pairs of casters can be in contact with a ground surface at the same time as the at least two fixed wheels; and wherein the at least two fixed wheels are connected to the at least one drive unit to be selectively rotatably moved thereby.

5. The device of claim 4, wherein the at least two pairs of casters are movable between an extended position and a retracted position; wherein the extended position is defined as the at least two pairs of casters being extended to a position substantially level with the at least two fixed wheels so that the at least two fixed wheels and each of the pairs of casters are in contact with the ground surface at the same time; and wherein the retracted position is defined as the at least two pairs of casters being retracted to a position so that only one pair of the at least two pairs of casters are capable of being in contact with the ground surface at the same time as the at least two fixed wheels.

6. The device of claim 4, wherein the at least two fixed wheels are movable between an extended position and a retracted position; wherein the extended position is defined as the at least two fixed wheels being extended to a position that is further from the lower surface of the main body member than the at least two pairs of casters so that only one pair of the at least two pairs of casters are capable of being in contact with the ground surface at the same time as the at least two fixed wheels; and wherein the retracted position is defined as the at least two fixed wheels being retracted to a position so that each of the at least two pairs of casters are in contact with the ground surface.

7. The device of claim 1, further comprising a power unit carried by the main body member and configured to provide electrical power to the computation interface, the at least one drive unit, and the at least one sensor device; and wherein the power unit has a power interface that is adapted to be removably engaged in communication with external power sources.

8. The device of claim 1, wherein the computation interface further comprises an olfactory system that is configured to selectively produce and emit scents relating to at least one of food, beverages, and fragrances.

9. The device of claim 1, wherein the computation interface is in communication with the at least one drive unit; wherein the computation interface receives the at least one detection signal emitted from the at least one sensor device and generates and sends a wheel control signal based on the at least one detection signal, to the at least one drive unit; and wherein the at least one drive unit selectively rotatably moves at least one of the plurality of wheel members based on the wheel control signal received.

10. The device of claim 9, wherein the computation interface is in communication with a global position system (GPS); wherein the computation interface receives geographic position data from the GPS system relating to geographic positioning of the main body member and the top member relative to a surrounding environment; and wherein the computation interface generates the wheel control signal based on at least one of the geographic position data and the at least one detection signal received.

11. The device of claim 10, further comprising a data storage unit in communication with the computation interface, and a virtual map stored on the data storage unit, the virtual map being accessible by the computation interface; wherein the computation interface generates and updates the virtual map based on the at least one detection signal received and the geographic position data; and wherein the computation interface generates the wheel control signal based on at least one of the geographic position data, the at least one detection signal received, and the virtual map.

12. The device of claim 11, wherein the computation interface is in communication with at least one user device; and wherein the computation interface and the at least one user device are operable to transceive at least one service signal between one another relating to at least one of available refreshments, available dock space location, monetary transactions, location of the at least one user device, location of the service cart device, user selected refreshment, selected dock space location, and estimated wait time.

13. The device of claim 12, wherein upon the computation interface receiving the at least one service signal from the at least one user device the computation interface determines an initial route based on the virtual map and the at least one service signal received; wherein the computation interface generates the wheel control signal based on at least one of the geographic position data, the at least one detection signal received, the virtual map, the at least one service signal received, and the initial route; wherein the computation interface determines a secondary route responsive to the at least one detection signal received, based on at least one of the geographic position data, the virtual map, the at least one service signal received, and the initial route; and wherein the computation interface generates the wheel control signal based on at least one of the geographic position data, the at least one detection signal received, the virtual map, the at least one service signal received, the initial route, and the secondary route.

14. The device of claim 12, wherein each of the plurality of storage members comprises a respective active lock member and carries at least one refreshment comprising food or beverage; wherein each one of the plurality of storage members are moveable between an opened position and a closed position when the respective active lock member of the storage member is in an unlocked position; wherein each one of the plurality of storage members are not moveable to the opened position from the closed position when the respective active lock member of the storage member is in the locked position; wherein each respective lock member is selectively operable by the computation interface to move between the locked position and unlocked position; wherein the computation interface associates the at least one user device with at least one of the plurality of storage members by matching the at least one refreshment carried by the at least one storage member with the at least one service signal, to define an associated storage member and an associated user device; and wherein the computation interface selectively moves the respective active lock member of the associated storage member to the unlocked position upon a proximity detection of the associated user device and the associated storage member.

15. The device of claim 12, wherein the communication between the computation interface and the at least one user device is via at least one of a wireless network, wireless fidelity (Wi-Fi), Bluetooth, near field communication (NFC), radio-frequency identification (RFID), infrared (IR), long-range (LoRa), z-wave, ultrawideband (UWB), and light fidelity (Li-Fi).

16. The device of claim 1, further comprising a control interface carried by the main body member and in communication with the at least one drive unit; wherein the control interface is selectively operable by users to cause the at least one drive unit to rotatably move at least one of the plurality of wheel members and cause the service cart device to at least one of move forward, move backward, turn, and stop relative to a ground surface.

17. A service cart device to transport goods and services, the device comprising:
a main body member including a housing;
a plurality of storage members carried by the main body member;
a top member positioned above and carried by the main body member;
an attachment member attached to an upper portion of the top member and configured to be removably engaged with a lifting device;
a computation interface carried by the housing;
a plurality of wheel members rotatably attached to a lower surface of the main body member;
at least one drive unit to selectively rotatably move at least one of the plurality of wheel members;
at least one sensor device in communication with the computation interface and configured to detect objects and surfaces adjacent to the main body member and the top member; and
a data storage unit in communication with the computation interface;
wherein the at least one sensor device emits at least one detection signal relating to detected objects and surfaces;
wherein the computation interface is in communication with the at least one drive unit, a global position system (GPS), and at least one user device;
wherein the computation interface receives the at least one detection signal emitted from the at least one sensor device;
wherein the computation interface receives geographic position data from the GPS system relating to geographic positioning of the main body member and the top member relative to a surrounding environment;
wherein the computation interface generates and updates a virtual map based on the at least one detection signal and the geographic position data, and stores the virtual map on the data storage unit;
wherein the computation interface and the at least one user device are operable to transceive at least one service signal between one another relating to at least one of available refreshments, available dock space location, monetary transactions, location of the at least one user device, location of the service cart device, user selected refreshment, selected dock space location, and estimated wait time;
wherein the computation interface determines an initial route based on the virtual map and the at least one service signal;
wherein the computation interface determines a secondary route based on the initial route and responsive to the at least one detection signal;
wherein the computation interface generates and sends a wheel control signal based on at least one of the geographic position data, the at least one detection signal, the virtual map, the at least one service signal, the initial route, and the secondary route, to the at least one drive unit;
wherein the at least one drive unit selectively rotatably moves at least one of the plurality of wheel members based on the wheel control signal received; and
wherein the top member comprises a buoyant material.

18. The device of claim 17, further comprising a control interface carried by the main body member and in communication with the at least one drive unit; wherein the control interface is selectively operable by users to cause the at least one drive unit to rotatably move at least one of the plurality of wheel members and cause the service cart device to at least one of move forward, move backward, turn, and stop relative to a ground surface.

19. The device of claim 17, wherein the plurality of wheel members comprises at least two fixed wheels positioned on an intermediary portion of the lower surface of the main body member, and comprises at least two pairs of casters positioned on opposing sides of the lower surface of the main body member; wherein the at least two fixed wheels have a circumference that is larger than a circumference of the at least two pairs of casters so that only one pair of the at least two pairs of casters can be in contact with a ground surface at the same time as the at least two fixed wheels; and wherein the at least two fixed wheels are connected to the at least one drive unit to be selectively rotatably moved thereby.

20. A service cart device to transport goods and services, the device comprising:
a main body member including a housing;
a computation interface carried by the housing;
a plurality of storage members carried by the main body member and each comprising a respective active lock member that is in communication with and selectively controllable by the computation interface to move between a locked position and an unlocked position, wherein each one of the plurality of storage member is moveable between an opened position and a closed position when the respective active lock member is in the unlocked position, and not moveable between the opened position and the closed position when the respective active lock member is in the locked position;
a top member positioned above and carried by the main body member;
an attachment member attached to an upper portion of the top member and configured to be removably engaged with a lifting device;
a plurality of wheel members rotatably attached to a lower surface of the main body member;
at least one drive unit to selectively rotatably move at least one of the plurality of wheel members;
at least one sensor device in communication with the computation interface and configured to detect objects and surfaces adjacent to the main body member and the top member;
wherein the at least one sensor device emits at least one detection signal relating to detected objects and surfaces;
wherein the computation interface is in communication with the at least one drive unit, a global position system (GPS), and at least one user device;
wherein the computation interface receives geographic position data from the GPS system relating to geographic positioning of main body member and the top member relative to a surrounding environment;
wherein each one of the plurality of storage members carries at least one refreshment comprising food or beverage;
wherein the computation interface and the at least one user device are operable to transceive at least one service signal between one another relating to at least one of available refreshments, available dock space location, monetary transactions, location of the at least one user device, location of the service cart device, user selected refreshment, selected dock space location, and estimated wait time;
wherein the computation interface associates the at least one user device with at least one of the plurality of storage members by matching the refreshment carried by the at least one storage member with the at least one service signal received from the at least one user device, to define an associated storage member and an associated user device;
wherein the computation interface selectively moves the respective active lock member of the associated storage member to the unlocked position upon a proximity detection of the associated user device and the associated storage member; and
wherein the top member comprises a buoyant material.
